(19) United States
(12) Patent Application Publication
(10) Pub. No.: US 2010/0138404 A1
(43) Pub. Date: Jun. 3, 2010

(54) SYSTEM AND METHOD FOR SEARCHING FOR MUSICAL PIECES USING HARDWARE-BASED MUSIC SEARCH ENGINE

(76) Inventors: Chul Hong Park, Cary, NC (US); Jae Hong Park, Blacksburg, VA (US)

Correspondence Address: Thomas H. Ham;Wilson & Ham, PMB: 348, 2530 Berryessa Road, San Jose, CA, 95132, US

(21) Appl. No.: 12/325,394

(22) Filed: Dec. 1, 2008

(51) Int. Cl. G06F 7/06; G06F 17/30; G06F 7/00

(52) U.S. Cl. 707/712; 707/E17.108

(57) ABSTRACT

A system and method for searching for musical pieces utilizes a hardware-based music search engine that includes a systolic array of comparison circuits to correlate musical query data for a desired musical piece with at least some of musical information data from a music database to determine potential musical pieces that are candidates for the desired musical piece.

### FIELD OF THE INVENTION

The invention relates generally to music searches, and more particularly to a system and method for performing music searches using a music search engine.

### BACKGROUND OF THE INVENTION

Searching for musical pieces for purchase can be a relatively simple task when certain critical pieces of information about the musical pieces are unknown. These critical pieces of information typically include title, artist (performer) and composer. As an example, a desired musical piece can be readily found using an online music search engine at a music store website if the title, the artist or the composer is known. When the desired musical piece is found, the desired musical piece or the album including that musical piece can then be purchased at the music store website through an online purchasing process for download or physical delivery.

If none of these critical pieces of information for a desired musical piece is known, however, then the task of finding the desired musical piece online can be extremely difficult or even impossible. In some situations, an incomplete critical piece of information for a desired musical piece may be known. If the incomplete piece of information includes one or more incorrect words, then this information may be useless in finding the desired musical piece. As an example, if “I want to hold your land” is entered for online music search instead of “I want to hold your hand”, then the desired musical piece may not be found even though there is only one single letter difference between the entered text and the actual title of the musical piece.

In view of these issues, what is needed is a system and method for performing music searches that can find desired musical pieces even when only incomplete pieces of information about the musical pieces are known.

### SUMMARY OF THE INVENTION

A system and method for searching for musical pieces utilizes a hardware-based music search engine that includes a systolic array of comparison circuits to correlate musical query data for a desired musical piece with at least some of musical information data from a music database to determine potential musical pieces that are candidates for the desired musical piece.

A music search system in accordance with an embodiment of the invention comprises a music database of musical information data for musical pieces, a processor and a hardware-based music search engine. The musical information data in the music database includes at least one of lyric data and melodic data for each of the musical pieces. The processor is operatively connected to the music database to access the musical information data. The processor is configured to receive musical query data for a desired musical piece to search for potential musical pieces from the musical pieces in the music database. The hardware-based music search engine is operatively connected to the processor. The hardware-based music search engine includes a systolic comparison array of comparison circuits to correlate the musical query data with at least some of the musical information data from the music database to determine the potential musical pieces that are candidates for the desired musical piece.

A method of searching for musical pieces in accordance with an embodiment of the invention comprises receiving musical query data for a desired musical piece, accessing musical information data for musical pieces in a music database, the musical information data in the music database including at least one of lyric data and melodic data for each of the musical pieces, transmitting the musical query data and the musical information data to a hardware-based music search engine, which includes a systolic array of comparison circuits, and correlating the musical query data with at least some of the musical information data from the music database using the systolic array of comparison circuits of the hardware-based music search engine to determine potential musical pieces from the musical pieces that are candidates for the desired musical piece.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 is diagram of a music search system in accordance with an embodiment of the invention.

FIG. 2 is a diagram of a music search request webpage provided in the music search system in accordance with an embodiment of the invention.

FIG. 3 is a diagram of a music search result webpage provided in the music search system in accordance with an embodiment of the invention.

FIG. 4 is a block diagram of a music search computer system included in the music search system in accordance with an embodiment of the invention.

FIG. 5 is a block diagram of a hardware-based music search engine included in the music search system in accordance with an embodiment of the invention.

FIG. 6 is a diagram of connections between two comparison circuits of the hardware-based music search engine in accordance with an embodiment of the invention.

FIG. 7 is a block diagram of a comparison circuit of the hardware-based music search engine in accordance with an embodiment of the invention.

FIG. 8 is diagram of the music search system with multiple hardware-based music search engines in accordance with another embodiment of the invention.

FIG. 9 is a flow diagram of method of searching for musical pieces in accordance with an embodiment of the invention.

### DETAILED DESCRIPTION

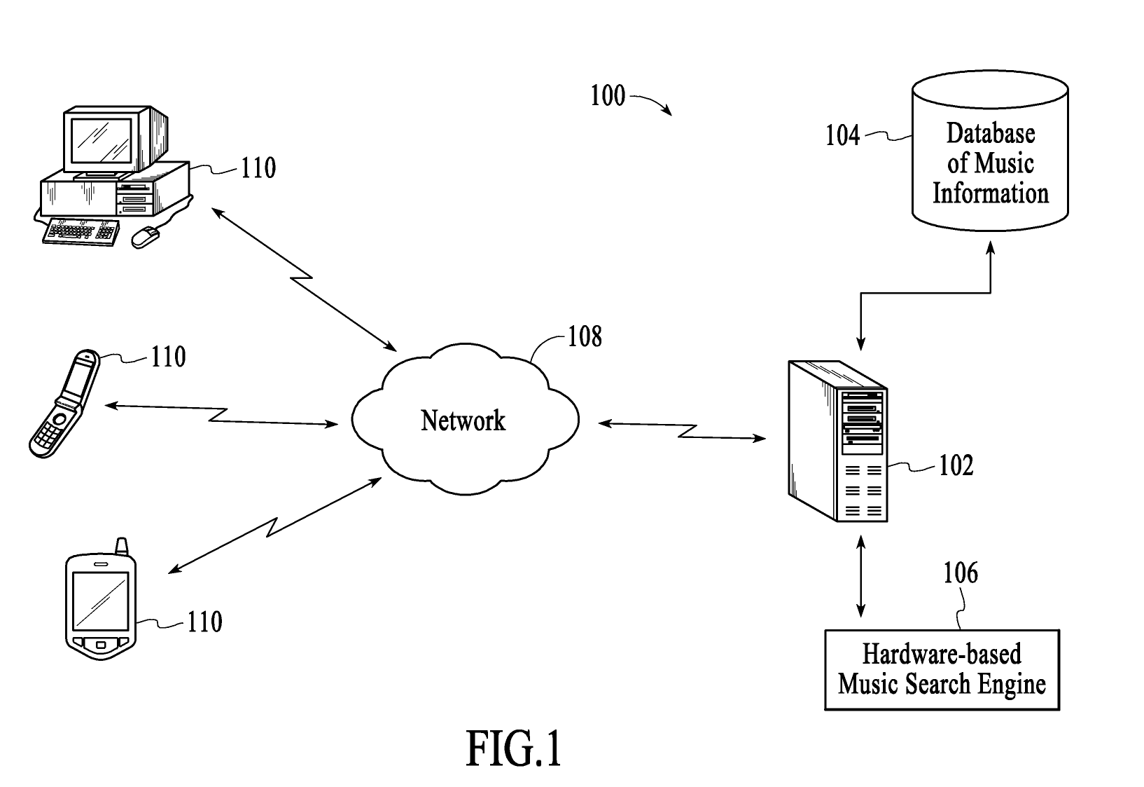

With reference to FIG. 1, a music search system 100 in accordance with an embodiment of the invention is described. As described in more detail below, the music search system 100 allows users to search for desired musical pieces even when critical pieces of information relating to the desired musical pieces, such as title, artist (performer) and composer, are unknown or partially known. In addition to these critical pieces of information, users may enter known or partially known musical segments of the desired musical pieces, as well as ancillary information relating to the musical pieces, to search for the desired musical pieces. Ancillary information of a desired musical piece may include nationality of the artist, related movie, period of time, class of music and other information of the desired musical piece. The music search system 100 performs music searches using a hardware-based music search engine, which is significantly faster than a comparable software-based music search engine.

As shown in FIG. 1, the music search system 100 includes a music search computer system 102, a database of music information 104 and a hardware-based music search engine 103. In an embodiment, the music search system 100 can be accessed by users through a computer network 108 using remote computer devices 110 connected to the computer network. The computer network 108 is described herein as the Internet. However, in other embodiments, the computer network 108 can be any type of computer networks, such as LAN and WAN. As illustrated in FIG. 1, the remote computer devices 110 may include personal computers, Internet-enabled cellular phones and Internet-enabled personal digital assistants (PDAs). However, the remote computer devices 110 may be any computer device that can connect to the computer network 108.

The music search computer system 102 operates to provide a music search interface for users to enter musical search inputs to search for desired musical pieces using the music search system 100. These musical search inputs may include known or partially known critical pieces of information for the desired musical pieces, such as title, artist and composer, known or partially known musical segments of the desired musical pieces, and/or ancillary information of the desired musical pieces. In an embodiment, the music search interface provided by the music search computer system 102 is a webpage, which can be accessed by users using a remote computer device, e.g., one of the remote computer devices 110, via the Internet 108.

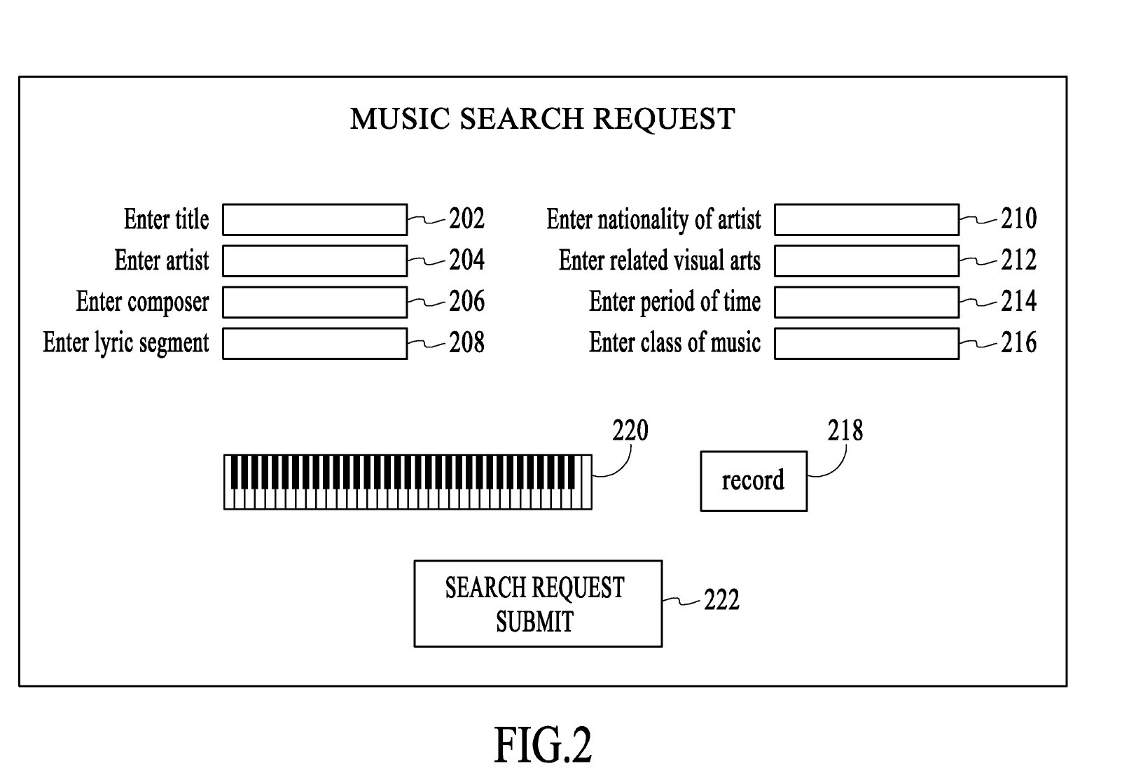

An example of a music search request webpage provided by the music search computer system is illustrated in FIG. 2. The music search request webpage includes a number of text boxes 202-216 for a user to enter information regarding a desired musical piece to be searched. As an example, the text boxes 202-216 may be used to enter title, artist, composer, lyric segment, nationality of artist, related visual arts (e.g., movie), period of time and class of music, respectively, for the desired musical piece. Each of these pieces of information for the desired musical piece may be correct or partially correct. As described in more detail below, even partially correct information can be used to search for the desired musical piece. In addition, all these pieces of information are not needed to perform the music search. Any number of these pieces of information can be entered to initial the music search.

As shown in FIG. 2, the music search request webpage further includes a recording button 218 and an interactive music input device 220. The recording button 218 or the interactive music input device 220 is used to enter a melodic segment of the desired musical piece. The recording button 218 is used to record a melodic segment of the desired musical piece using a microphone, which can be part of or connected to the remote computer device 110 being used for music search. After the recording button 218 is depressed, the melodic segment can be hummed or sung by a user or played on any instrument, and recorded through the microphone of the remote computer device 110 as a computer file, such as a midi file. The computer file can then be uploaded onto the webpage to be used for the music search. The interactive music input device 220 is used to input the melodic segment of the desired musical piece. In the illustrated embodiment, the interactive music input device 220 is in the form of a virtual piano keyboard to input musical notes. However, in other embodiments, the interactive music input device 220 can have a different form to input musical notes. The interactive music input device 220 can be played by the user to create and save the melodic segment of the desired musical piece as a computer file, such a midi file.

As shown in FIG. 2, the music search request webpage further includes a submit button 222 to initiate the music search using the information entered by the user with respect to the desired musical piece. When the submit button 222 is activated, the information entered on the music search request webpage, including the computer file of the recorded or played melodic segment, is transmitted to the music search computer system 102 via the computer network 108. The music search computer system 102 then processes the received information to search for potential musical pieces that most likely match the desired musical piece using the hardware-based music search engine 106 and the database of music information 104, as described in more detail below.

In an embodiment, the music search computer system 102 further operates to provide the results of a music search in the form of a music search result website to the remote computer device 110 of the user requesting the music search. The music search result webpage includes a list of one or more potential musical pieces that most likely match the desired musical piece as determined by the music search computer system 102 using the information entered and/or recorded by the user on the music search webpage. The list of potential musical pieces may include identifying information for each of the found musical pieces, such as title and artist. The list of potential musical pieces may also include a relevance value for each of the found musical pieces. The relevance value of a potential musical piece is a value that indicates the likelihood that the potential musical piece is the desired musical piece.

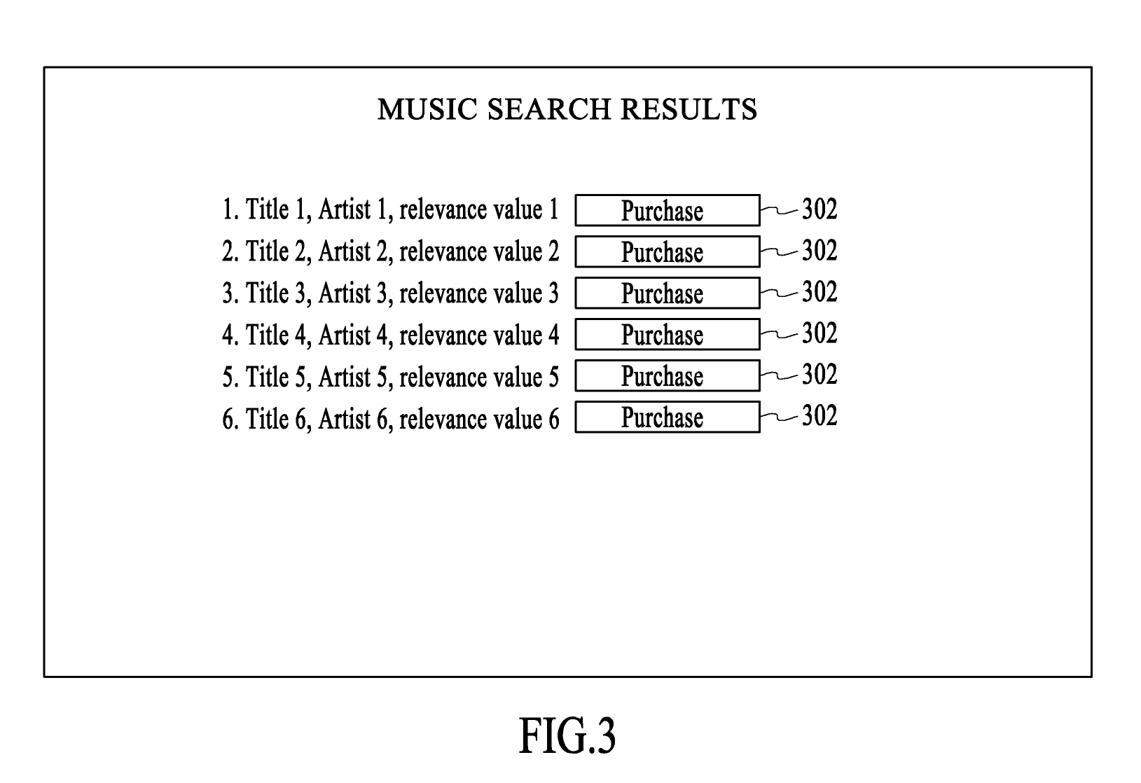

An example of a music search result webpage provided by the music search computer system 102 is illustrated in FIG. 3. The music search result webpage includes a list of found musical pieces that potentially match the desired musical piece using the criteria entered for the music search. As illustrated in FIG. 3, for each found musical piece, the title and the artist for that found musical piece are provided. However, in other embodiments, other information for each found music piece may be provided. In the illustrated embodiment, for each found musical piece, a relevance value is also provided. A relevance value shows the likelihood of that found musical piece being a match for the desired musical piece using the entered criteria. In an embodiment, the music search result webpage may also include a mechanism to purchase any of the found musical pieces. As illustrated in FIG. 3, the music search result webpage may include a purchase button 302 for each of the found musical pieces. In one embodiment, the purchase button 302 may be a hyperlink to an associated online music store so that the user can purchase one or more found musical pieces at the associated online music store. In another embodiment, the purchase button 302 may be part of a checkout process for the user to purchase one or more found musical pieces at the current website.

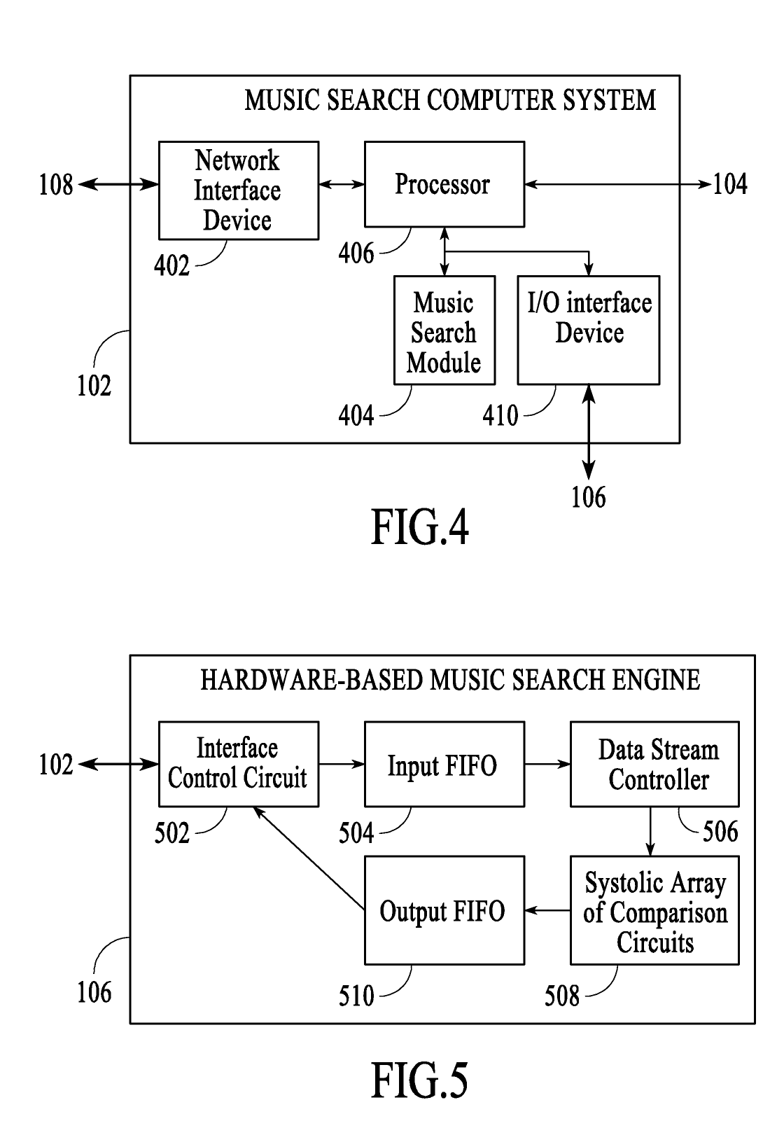

Turning now to FIG. 4, the components of the music search computer system 102 in accordance with an embodiment of the invention are shown. In an embodiment, the music search computer system 102 is a server or a number of servers connected to the computer network 108, i.e., the Internet, to provide music search request and music search result webpages and other related webpages that can be accessed using remote computer devices, such as the remote computer devices 110.

As shown in FIG. 4, the music search computer system 102 includes a network interface device 402, a music search module 404, a processor 406 and an input/output (I/O) interface device 410. The network interface device 402 is configured to interface with the computer network 108 either directly or indirectly to transmit and receive data to and from the remote computer devices 110 through the computer network. As an example, the network interface device 108 may be a network interface card. The music search module 404 operates to perform tasks associated with music searches in accordance with an embodiment of the invention. The music search module 404 provides music search request webpages and music search result webpages. The music search module 404 also processes information entered for requested musical pieces to initiate music searches and processes data relating to music search results to provide music search result webpages to the requested remote computer devices 110. The music search module 404 also controls the transmission of information entered for requested musical pieces to the hardware-based music search engine 106. The music search module 404 also controls the transmission of data in the database 104 of music information to the hardware-based music search engine 106 for each music search request. In an embodiment, the music search module 404 is implemented as software. However, in other embodiments, the music search module 404 may be implemented in any combination of hardware, firmware and/or software.

The processor 406 may be any type of digital signal processor that can run the music search module 404. Although the music search computer system 102 is shown with one processor, the music search computer system may include multiple processors. The processor 406 is connected to the database 104 to access the music information in the database 104, which can be stored in any storage medium. As shown in FIGS. 1 and 4, the database 104 may be located outside of the music search computer system 102. In other embodiments, the database 104 may be located within the music search computer system 102.

The I/O interface device 410 is configured to interface with the hardware-based music search engine 106 to transmit data between the music search computer system 102 and the hardware-based music search engine at a high rate of speed. As an example, the I/O interface device 410 may be a PCI-Express card. In an embodiment, the I/O interface device 410 is connected to the hardware-based music search engine 106 via a physical connection, such as a cable. However, in other embodiments, the I/O interface device 410 may be wirelessly connected to the hardware-based music search engine 106.

The database 104 of music information includes a set of information for each musical piece stored in the database. The information for musical pieces stored in the database 104 can be compared with the information entered by a user for a desired musical piece to produce a list of potential musical pieces that may match the desired musical piece. Thus, the database 104 of music information includes sets of information for musical pieces that correspond to the pieces of information that users can enter to search for desired musical pieces. As an example, the database 104 of music information includes title, artist, composer, lyric segment, nationality of artist, related movie(s), period of time, class of music and complete melodic sequence for each musical piece stored in the database. In an embodiment, each melodic sequence for a particular musical piece stored in the database 104 includes notes, rests and duration information for a single track of the particular musical piece, for example, the melody of the musical piece. As an example, the single track may be the vocal track or another melodic track of the particular musical piece. As another example, the single track may be the resulting track of combining multiple tracks of the particular musical piece into one single track. Multiple tracks can be catenated one track after another into one track.

The database 104 of music information is accessible by the processor 406 of the music search computer system 102 to readout the stored information of musical pieces stored in the database during a music search operation. As described below, when a music search request is received at the music search computer system 102, the information from the database 104 is readout and transmitted to the hardware-based music search engine 106 to be correlated with the user-entered information for a desired musical piece, which is also transmitted to the music search engine as query data.

Turning now to FIG. 5, the components of the hardware-based music search engine 106 in accordance with an embodiment of the invention are shown. The hardware-based music search engine 106 is a music search engine that compares the query data relating to a desired musical piece with the database data to find potential musical pieces in the database 104 of music information that may match the desired music piece. Since the hardware-based music search engine 106 utilizes hardware rather than software, the hardware-based music search engine is able to perform music search comparisons at a much higher speed than a comparable software-based music search engine.

As shown in FIG. 5, the hardware-based music search engine 106 includes an interface control circuit 502, an input first-in first-out (FIFO) 504, a data stream controller 506, a systolic array 508 of comparison circuits and an output FIFO circuit 510. The interface control circuit 502 operates to control data traffic for receiving the query data and database data from the music search computer system 102 and for sending the comparison results to the music search computer system. In an embodiment, the interface control circuit 502 may be a PCIE controller. The input FIFO 504 is connected to the interface control circuit 502 to receive the incoming data from the music search computer system 102 to buffer and control the incoming data flow. The output of the input FIFO 504 is connected to the data stream controller 506 to transmit the data from the interface control circuit 502 to the data stream controller.

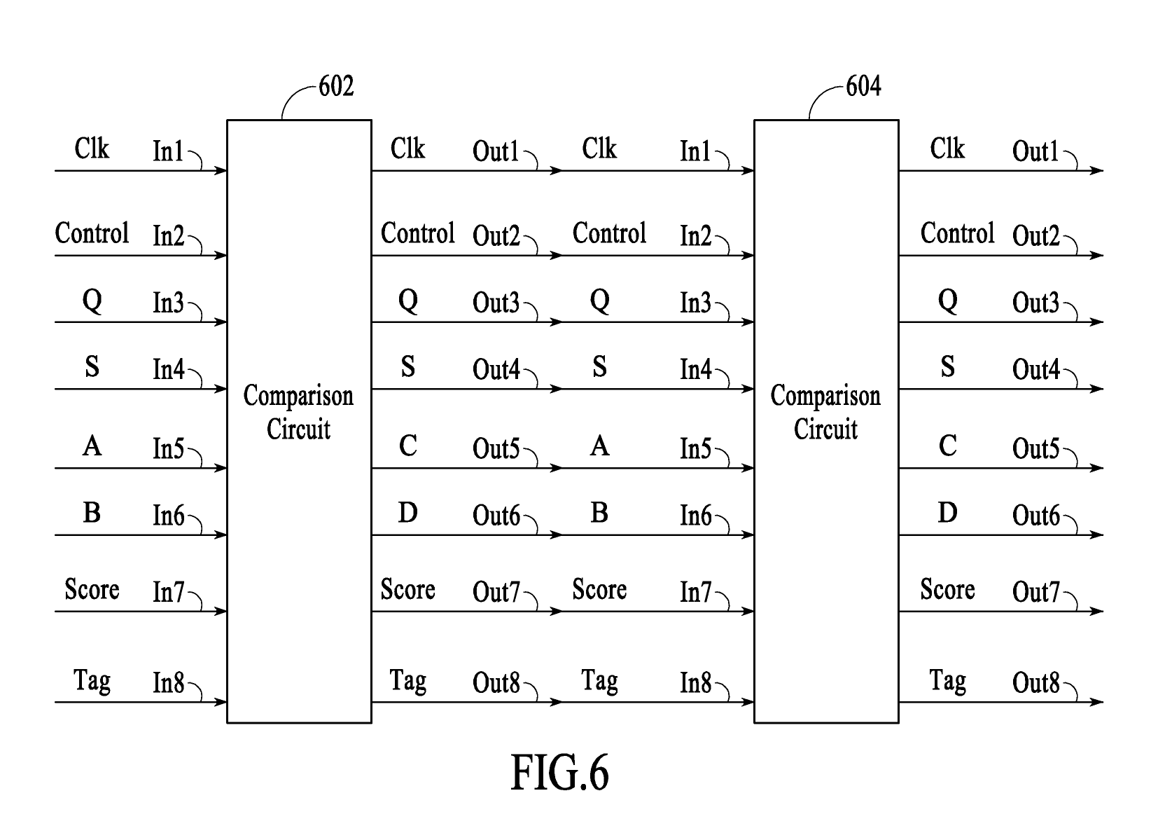

The data stream controller 506 is configured to process the received data and organize the data for transmission to the systolic comparison array 508. The data stream controller 506 transmits the query data as a stream of data on a query bus (shown in FIG. 6) and the database data as another stream of data on a database bus (shown in FIG. 6) to the systolic comparison array 508. The data stream controller 506 also transmits control data on a control bus (shown in FIG. 6) to the systolic comparison array 508.

The systolic comparison array 508 is configured to compare or correlate the query data with the database data using comparison circuits. As an example, the systolic comparison array 508 may be configured to compare a textual query sequence, which represents a partial lyric sequence of a desired musical piece, with textual database sequences, which represent complete lyric sequences of musical pieces stored in the music database 104. As another example, the systolic comparison array 508 may also be configured to compare a melodic query sequence, which represents musical notes and their duration for a partial melodic sequence of a desired musical piece, with melodic database sequences, which represent musical notes and their duration for complete melodic sequences of musical pieces stored in the music database 106.

The results of comparisons or correlations are transmitted from the systolic comparison array 508 to the output FIFO 510 as output data. The output data includes a list of potential musical pieces that may match the desired musical piece being searched. In an embodiment, the potential musical pieces are prioritized based on a scoring scheme, which takes into consideration how close query data match corresponding database data for a particular potential musical piece. The systolic comparison array 508 is described in more detail below.

The output FIFO 510 is connected to the systolic comparison array 508 to receive the output data from the systolic comparison array to buffer and control the outgoing data flow. The output FIFO 510 is also connected to the interface control circuit 502 to transmit the output data to the music search computer system 102 via the network 108. The output data is then used by the music search computer system 102 to produce a music search result webpage for the requesting remote computer device 110.

In an embodiment, the systolic comparison array 508 is configured to execute Smith-Waterman calculations to derive Smith-Waterman scores, which are transmitted to the music search computer system 102 as part of the output data. Smith-Waterman scores indicate a degree of similarity between two sequences, for example, a user-entered lyric sequence and a portion of a lyric sequence for a musical piece stored in the database 104. Smith-Waterman scores not only count matches and mismatches of sequence elements between two sequences but also insertions and deletions of sequence elements between the two sequences, as explained below using an example.

In this example, two sequences being compared are STOMACHE (query sequence) and STOOMCHT (database sequence). A sequence comparison match between the two sequences can be expressed as follows:

STO*MACHE

STOOM-CHT,

where “*” indicates deletion and “-” indicates insertion from the point of view of the query sequence. The deletion and insertion should be switched if viewed from the point of view of the database sequence. Note that “E” in STOMACHE does not match “T” in STOOMCHT. Thus, a sequence comparison match does not require each sequence element in one of the sequences to match a corresponding sequence element in the other sequence.

In order to derive the Smith-Waterman score for this sequence comparison match, the systolic comparison array 508 calculates a score value for each cell in the following Smith-Waterman score table.

TABLE 1

| | | | | | | | |
|---|---|---|---|---|---|---|---|
| S | T | O | M | A | C | H | E |
| (j = 1) | (j = 2) | (j = 3) | (j = 4) | (j = 5) | (j = 6) | (j = 7) | (j = 8) |

| | | |
|---|---|---|
| S | | |
| (m = 1) | | |
| T | | |
| (m = 2) | | |
| O | H_{m-1,j-1} | H_{m-1,j} |
| (m = 3) | | |
| O | H_{m,j-1} | H_{m,j} |
| (m = 4) | | |
| M | | |
| (m = 5) | | |
| C | | |
| (m = 6) | | |
| H | | |
| (m = 7) | | |
| T | | |
| (m = 8) | | |

The elements Qⱼ of the query sequence, STOMACH, define the columns of the above table, and the elements Sₘ of the subject sequence, STOOMCHT, define the rows of the table. Thus, each cell in the table can be identified by a row number m and a column number j. Assuming a Smith-Waterman cell score is represented by H, the Smith-Waterman cell score in each cell can be expressed as H_{m,j}. For example, the score in the upper left corner at row “S” or m=1 and column “S” or j=1 can be expressed as H_{1,1}.

Each Smith-Waterman cell score can be calculated using Smith-Waterman cell scores from certain neighboring cells and predefined scores for match, mismatch, insertion and deletion conditions. In general, a Smith-Waterman cell score, H_{m,j}, can be calculated as: H_{m,j}=max(H_{m-1,j-1}+b, H_{m,j-1}+i, H_{m-1,j}+g, 0), where b equals a (award) when Sₘ is Qⱼ or b equals p (mismatch penalty) when Sₘ is not Qⱼ, i equals insertion penalty, and g equals deletion penalty. Thus, the Smith-Waterman cell score for a particular cell in the above table can be calculated using Smith-Waterman cell scores from adjacent cells that are located above and to the left of the particular cell, directly to the left of the particular cell, and directly above the particular cell, along with the predefined scores for match, mismatch, insertion and deletion conditions.

As an example, in order to compute the Smith-Waterman cell score for the cell at row 4 and column 4, i.e., H_{4,4}, the Smith-Waterman cell scores for the cell at row 3 and column 4, for the cell at row 4 and column 3 and for the cell at row 3 and column 4 are used. In this example, as shown in the above table, the Smith-Waterman cell scores for the cell at row 3 and column 4, for the cell at row 4 and column 3, for the cell at row 3 and column 4 and for the cell at row 4 and column 4 are indicated as H_{m-1,j-1}, H_{m,j-1}, H_{m-1,j}, and H_{m,j}, respectively. For simplicity, H_{m-1,j-1}, H_{m,j-1}, H_{m-1,j}, and H_{m,j} will be hereinafter be referred to as A, B, C and D respectively. In this example, the Smith-Waterman cell score to be calculated is D. In order to calculate the Smith-Waterman cell score D for the cell at row 4 and column 4, the Smith-Waterman cell scores A, B and C and the predefined conditions scores b, i and g are used.

The Smith-Waterman cell scores for cells along the top row, i.e., row 1, and for cells along the far left column, i.e., column 1, can be calculated by assuming that A, B and/or C are zero. As an example, for the cell at row 1 and column 1, the Smith-Waterman cell score can be calculated with the assumption that A, B and C are equal to zero. In this example, the Smith-Waterman cell score will be “a” because S₁ is equal to Q₁, i.e., a match condition. As another example, for the cell at row 1 and column 2, the Smith-Waterman cell score can be calculated by assuming that A and C equal to zero and by setting B equal to “a”.

Below is a completed Smith-Waterman score table for the sequence comparison between the database sequence, STOOMCHT, and the query sequence, STOMACHE, with the assumption that a (match award) is equal to 1, p (mismatch penalty) is equal to −2, g (deletion penalty) is equal to −1 and i (insertion penalty) is equal to −1.

TABLE 2

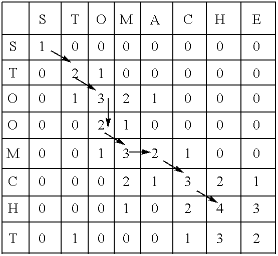

The final Smith-Waterman score for the sequence comparison is the highest Smith-Waterman cell score, which is 4 for the cell at row 7 and column 7. The arrows in the above table indicate alignments that include the highest Smith-Waterman cell score for the sequence comparison.

The systolic comparison array 508 is configured to execute Smith-Waterman calculations to derive Smith-Waterman score for each sequence comparison using the technique described above. The systolic comparison array 508 is configured to calculate each Smith-Waterman cell score for a sequence comparison and to output the highest cell score as the Smith-Waterman score for that sequence comparison. In an embodiment, the systolic comparison array 508 is configured to calculate some of the cells simultaneously, e.g., the crosshatched cells in Table 1. At the first element of the data input stream, only cell (m=1, j=1) will be calculated by the systolic comparison array 508. At the second element, cell (m=1, j=2) and cell (m=2, j=1) will be calculated simultaneously by the systolic comparison array 508. At the third element, cell (m=3, j=1), cell (m=2, j=2) and cell (m=1, j=3) will be calculated simultaneously by the systolic comparison array 508. At the forth element, cell (m=4, j=1), cell (m=3, j=2), cell (m=2, j=3) and cell (m=1, j=4) will be calculated simultaneously by the systolic comparison array 508. Thus, the simultaneous calculations by the systolic comparison array 508 occur in diagonal patterns.

Turning now to FIG. 6, two adjacent comparison circuits 602 and 604 of the systolic comparison array 508 are shown to illustrate connections between the comparison circuits of the systolic comparison array in accordance with an embodiment of the invention. As shown in FIG. 6, each of the comparison circuits 602 and 604 of the systolic comparison array 508 includes input terminals In1 to In8 to receive input signals from an adjacent previous comparison circuit, which in FIG. 6 would be the comparison circuit 602 for the comparison circuit 604. The input terminal In1 is used to receive a clock signal (Clk), which is used by various components of the comparison circuit 602. The input terminal In3 is used to receive query data Q, while the input terminal In4 is used to receive database data S. The input terminal In2 is used to receive a control signal, which is used to select between Q and S for comparison. The input terminal in5 is used to receive the current A (H_{m-1,j-1}) value, while the input terminal In6 is used to receive the current B (H_{m,j-1}) value. As described in more detail, each comparison circuit is configured to calculate C (H_{m-i,j}) and D (H_{m,j}) values using the received A and B values. The input terminal In7 is used to receive the current highest Smith-Waterman score. The input terminal In8 is used to receive a tag signal, which represents the musical piece associated with the current highest Smith-Waterman score.

Each of the comparison circuits 602 and 604 also includes output terminals Out1 to Out8 to transmit output signals to the next comparison circuit of the systolic comparison array 508, which in FIG. 6 would be the comparison circuit 604 for the comparison circuit 602. The output terminal Out1 is used to transmit the clock signal (Clk). The output terminal Out3 is used to transmit the query data Q, while the output terminal Out4 is used to transmit the database data S. The output terminal Out2 is used to transmit the control signal. The output terminal Out5 is used to transmit the calculated C value, which is received by the next comparison circuit as the A value. Similarly, the output terminal Out6 is used to transmit the calculated D value, which is received by the next comparison circuit as the B value. The output terminal Out 7 is used to transmit the current highest Smith-Waterman score. The output terminal Out 8 is used to transmit the current tag signal associated with the current highest Smith-Waterman score. For the last comparison circuit of the systolic comparison array 508, only the output terminals Out7 and Out 8 are connected to the output FIFO 510 to transmit the final Smith-Waterman scores and the associated tag signals to the music search computer system 102, which uses the received final Smith-Waterman scores and the associated tag signals to create a music search result webpage.

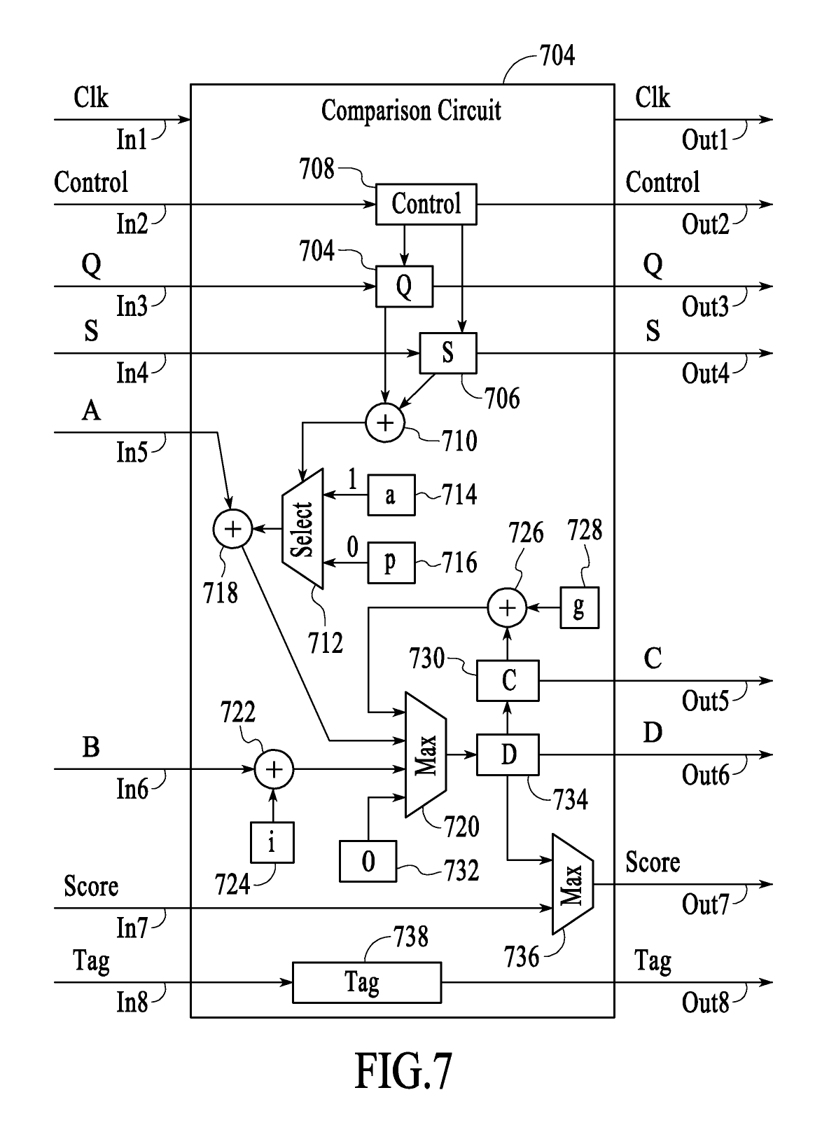

Turning now to FIG. 7, components of a comparison circuit 702 used in the systolic comparison circuit 508 in accordance with an embodiment are shown. The comparison circuit 702 includes the input terminals In1-In8 and the output terminals Out1-Out8, which were described above with reference to FIG. 6. As show in FIG. 7, the comparison circuit 702 includes registers 704 and 706, which temporality store query data Qⱼ and database data Sₘ, respectively. The register 704 is connected to the input terminal In3 to receive the query data Qⱼ and is also connected to the output terminal Out3 to transmit the query data Qⱼ to the next comparison circuit. Similarly, the register 706 is connected to the input terminal In4 to receive the database data Sₘ and is also connected to the output terminal Out4 to transmit the database data Sₘ to the next comparison circuit. The registers 704 and 706 are also connected to a control register/decoder 708, which controls the registers 704 and 706. The control register/decoder 708 is connected to the input terminal In2 to receive the control signal and to the output terminal out2 to transmit the control signal to the next comparison circuit. The control register/decoder 708 operates to instruct the registers 704 and 706 to selectively output the stored data Qⱼ and Sₘ in the registers to a comparison operator 710, which compares the received data to see if they match.

The output of the comparison operator 710 is connected to a select operator 712, which is connected to constant registers 714 and 716 to receive values stored in the registers 714 and 716. Stored in the constant register 714 is the value of a, which is a predefined value. Similarly, stored in the constant register 716 is the value of p, which is also a predefined value. The output of the select operator 712 is connected to a summing operator 718. If the data Qⱼ and Sₘ are a match, then select operator 712 outputs the value a. However, if the data Qⱼ and Sₘ are a mismatch, then select operator 712 outputs the value p. The summing operator 718 is also connected to the input terminal In5 to receive the current A value. The summing operator 718 adds the received A value with the a or p value from the select operator 712 to produced a summed value A+(a or p). The output of the summing operator 718 is connected to a max operator 720 to transmit the summed value to the max operator.

The max operator 720 is also connected to a summing operator 722, which is connected to the input terminal In6 to receive the current B value. The summing operator 722 is also connected to a constant register 724. Stored in the constant register 724 is the value of i, which is a predefined value. The summing operator 722 adds the received B value with the i value, if there is an insertion, to produced a summed value B+i, which is transmitted to the max operator 720.

The max operator 720 is also connected to a summing operator 726, which is connected to a constant register 728 and a register 730. Stored in the constant register 728 is the value of g, which is a predefined value. The register 730 is used to store the current C value, which is derived using the received A and B values. The register 730 is also connected to the output terminal Out5 to transmit the current C value to the next comparison circuit, which will be used as the A value in the next comparison circuit. The summing operator 726 adds the C value from the register 730 with the g value from the constant register 728, if there is a deletion, to produce a summed value C+g, which is transmitted to the max operator 720.

The max operator 720 is also connected to a constant register 732. Stored in the constant register 732 is the value of zero, which is transmitted to the max operator 720. The max operator 720 selects the highest value from the received values and outputs the highest value to a register 734 as the current D value. The register 734 is connected to the output terminal Out6 to transmit the current D value to the next comparison circuit, which will be used as the B value in the next comparison circuit. The register 734 is also connected to a max operator 736, which is also connected to the input terminal In7 to receive the current highest Smith-Waterman score. The max operator 736 is also connected to the output terminal Out7 to transmit either the value from the input terminal In6 or the current D value as the new current highest Smith-Waterman score to the next comparison circuit or the output FIFO 510.

The comparison circuit 702 also includes a register 738, which is connected to the input terminal In8 to receive the tag signal and to the output terminal Out8 to transmit the tag signal to the next comparison circuit or the output FIFO 510. The tag signal is updated in the following manner. The data stream controller 506 captures a tag signal from data input stream and feeds it to the tag register 738 of the first systolic array element, i.e., the first comparison circuit, and keeps feeding it until the next data input stream. When the next data input stream arrives, the tag signal from this new data input stream is captured and then fed in the same manner until the next data input stream.

In an embodiment, the systolic comparison array 508 is implemented using one or more field-programmable gate arrays (FPGAs). However, in other embodiments, the systolic comparison array 805 may be implemented using one or more application-specific integrated circuits (ASICs) or using any hardware-based logic devices.

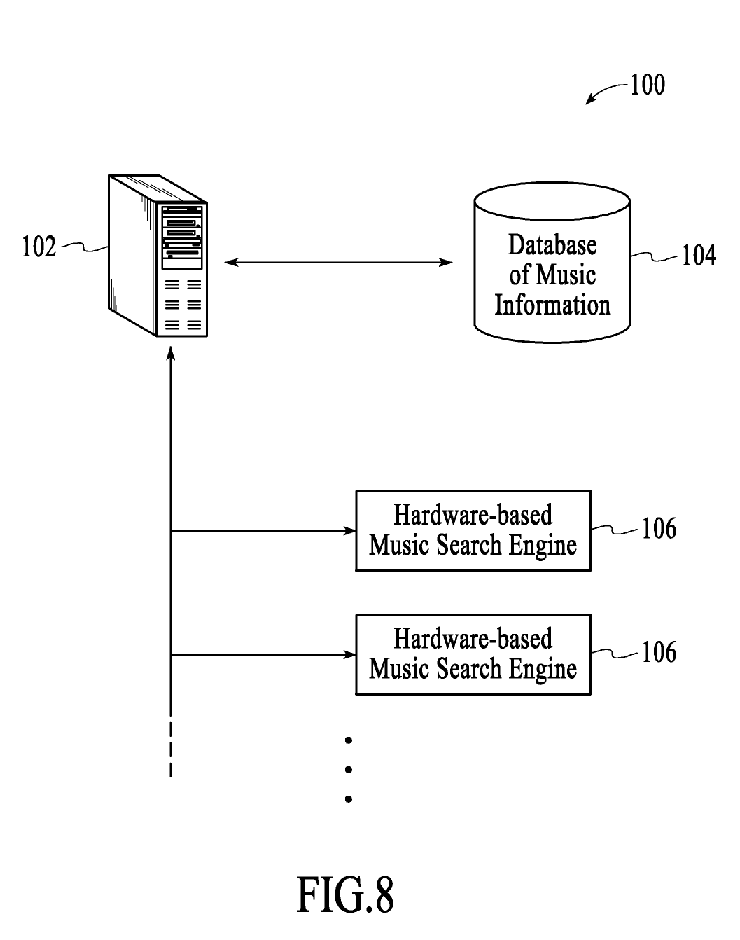

Although the music search system 100 has been described herein as including one hardware-based music search engine, i.e., the hardware-based music search engine 106, the music search system 100 may include multiple hardware-based music search engines connected to the music search computer system 102, as illustrated in FIG. 8. With multiple hardware-based music search engines 106, the music information from the music database 104 can be divided into smaller music databases of music information such that the music information of each smaller music database can be searched using one of the multiple hardware-based music search engines. Alternatively, with multiple hardware-based music search engines 106, the music search system 100 can perform multiple music searches simultaneously.

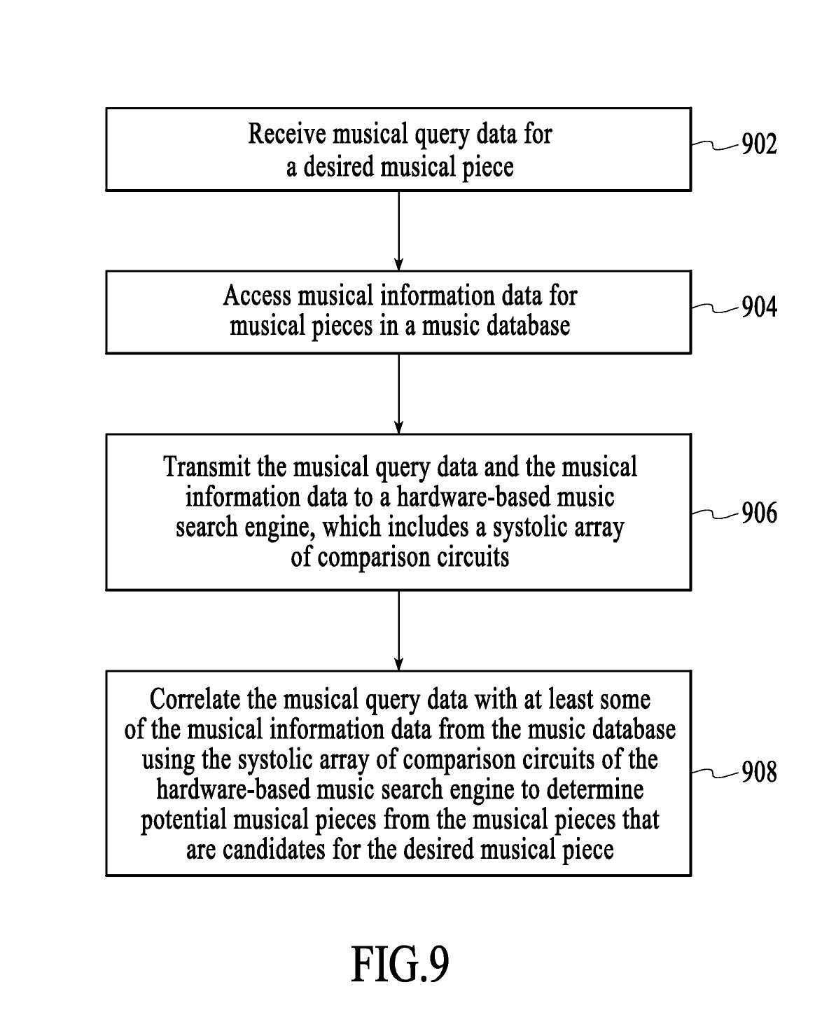

A method of searching for musical pieces in accordance with an embodiment of the invention is described with reference to a flow diagram of FIG. 9. At block 902, musical query data for a desired musical piece is received. At block 904, musical information data for musical pieces in a music database is accessed. The musical information data in the music database includes at least one of lyric data and melodic data for each of the musical pieces. At block 906, the musical query data and the musical information data are transmitted to a hardware-based music search engine, which includes a systolic array of comparison circuits. At block 908, the musical query data is correlated with at least some of the musical information data from the music database using the systolic array of comparison circuits of the hardware-based music search engine to determine potential musical pieces from the musical pieces that are candidates for the desired musical piece.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A system for searching for musical pieces, said system comprising:
a music database of musical information data for musical pieces, said musical information data in said music database including at least one of lyric data and melodic data for each of said musical pieces;
a processor operatively connected to said music database to access said musical information data, said processor being configured to receive musical query data for a desired musical piece to search for potential musical pieces from said musical pieces in said music database; and
a hardware-based music search engine operatively connected to said processor, said hardware-based music search engine including a systolic comparison array of comparison circuits to correlate said musical query data with at least some of said musical information data from said music database to determine said potential musical pieces that are candidates for said desired musical piece.

2. The system of claim 1 wherein said systolic comparison array is configured to calculate score values for said potential musical pieces, each of said score value indicating a likelihood of a match between said musical query data and a portion of said musical information data for one of said potential musical pieces.

3. The system of claim 2 wherein said systolic comparison array is configured to calculate Smith-Waterman score values for said potential musical pieces.

4. The system of claim 3 wherein said systolic comparison array is configured to calculate said Smith-Waterman score values using the following expression:
H_{m,j}=max(H_{m-1,j-1}+b, H_{m,j-1}+i, H_{m-1,j}+g, 0),
where H is a Smith-Waterman score value, m is a row number in a Smith-Waterman score table, j is a column number in the Smith-Waterman score table, b is one of a match award value and a mismatch penalty value, i is an insertion penalty value and g is a deletion penalty value.

5. The system of claim 1 further comprising a music search computer system operatively connected to said music database and said hardware-based music search engine, said music search computer system including said processor, said music search computer system being connected to a network to provide a graphic user interface to enter said musical query data at remote computer devices connected to said network.

6. The system of claim 5 wherein music search computer system includes a server connected to said network.

7. The system of claim 6 wherein said music search computer system is configured to provide said graphic user interface as webpages.

8. The system of claim 6 wherein said music search computer system is configured to provide a music search request webpage, said music search request webpage including an interactive graphic musical device to enter melodic information for said desired musical piece.

9. The system of claim 6 wherein said music search computer system is configured to provide said music search request webpage that includes a graphic text box to enter one of title, artist, composer, lyric segment, nationality of artist, related visual arts, period of time and class of music for said desired musical piece.

10. The system of claim 1 wherein said musical information data for said musical pieces in said music database includes single musical track information for each of said musical pieces.

11. A method of searching for musical pieces, said method comprising:
receiving musical query data for a desired musical piece;
accessing musical information data for musical pieces in a music database, said musical information data in said music database including at least one of lyric data and melodic data for each of said musical pieces;
transmitting said musical query data and said musical information data to a hardware-based music search engine, said hardware-based music search engine including a systolic array of comparison circuits; and
correlating said musical query data with at least some of said musical information data from said music database using said systolic array of comparison circuits of said hardware-based music search engine to determine potential musical pieces from said musical pieces that are candidates for said desired musical piece.

12. The method of claim 11 wherein said correlating includes calculating score values for said potential musical pieces, each of said score value indicating a likelihood of a match between said musical query data and a portion of said musical information data for one of said potential musical pieces.

13. The method of claim 12 wherein said calculating includes calculating Smith-Waterman score values for said potential musical pieces.

14. The method of claim 13 wherein said calculating said Smith-Waterman score values for said potential musical pieces using the following expression:
H_{m,j}=max(H_{m-1,j-1}+b, H_{m,j-1}+i, H_{m-1,j}+g, 0),
where H is a Smith-Waterman score value, m is a row number in a Smith-Waterman score table, j is a column number in the Smith-Waterman score table, b is one of a match award value and a mismatch penalty value, i is an insertion penalty value and g is a deletion penalty value.

15. The method of claim 11 further comprising providing a graphic user interface to enter musical query data at remote computer devices connected to a network, said hardware-based music search engine being also connected to said network.

16. The method of claim 15 wherein said providing includes providing said graphic user interface as webpages.

17. The method of claim 16 wherein said providing said graphic user interface as said webpages includes providing a music search request webpage, said music search request webpage including an interactive graphic musical device to enter melodic information for said desired musical piece.

18. The method of claim 17 wherein said providing said graphic user interface as said webpages includes providing said music search request webpage that includes a graphic text box to enter one of title, artist, composer, lyric segment, nationality of artist, related visual arts, period of time and class of music for said desired musical piece.

19. The method of claim 11 wherein said accessing said musical information data includes accessing single musical track information for each of said musical pieces.
